(19) United States
(12) Patent Application Publication
(10) Pub. No.: US 2008/0091943 A1
(43) Pub. Date: Apr. 17, 2008

(54) Data security device and the method thereof

(76) Inventors: Fu-Cheng Wu, Hsinchu City (TW); Wei-Bin Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,412

(22) Filed: Oct. 12, 2007

(30) Foreign Application Priority Data
Oct. 13, 2006 (TW) 95137758

(51) Int. Cl. H04L 9/28

(52) U.S. Cl. 713/165

(57) ABSTRACT

A data security device and the method thereof are provided for transmission security via a USB port. A USB protocol analyzer of the data security device is provided for determining the signal type, so as to encrypt a storage data signal but not a command signal. Therefore, the part of the USB device not for storage (such as a mouse) can work normally. The data security device determines the file system format of the storage data signal by a file system analyzer and encrypts a data block of the storage data signal by an encrypt unit, thereby a filename of the encrypted storage data signal can be obtained and the USB device can be used on other hosts.

### BACKGROUND OF THE INVENTION

1. Field of the Invention

The present invention relates to a data security device and the method thereof, and more particularly to a USB device for encrypting/decrypting transmitted data and the method thereof.

2. Description of Related Art

As information blooms, the quantity and complexity of information become increasingly higher and more complicated, and thus high-tech products are usually adopted to improve the working efficiency for the work of transmitting and maintaining information. For example, it is very common in our daily life to use information transmitted from network resources such as FTP, MSN or E-Mail or information stored in various different storage media such as CD, floppy disk or flash disk, so that the distribution of information can be more efficient, in addition to greatly enhancing the portability of information.

Particularly, the present popular USB interface portable storage devices generally have advantages such as a fast transmission rate, a high capacity, and a light, thin, short and compact design, so that USB interface portable storage devices have become one of the popular information storage hardware. The aforementioned storage devices can be simply connected to a computer host with a USB interface for quickly downloading a large quantity of required information into the portable storage devices. Since the portable storage devices are very convenient, it also creates an issue of information security, and it is quite often for companies to seal a USB port of the portable storage device with a sticker to prevent unauthorized people from stealing confidential information. However, the issue of information security becomes increasingly important regardless of the information being downloaded to the portable storage device, or saved in the portable storage device due to the convenience of information transmission and information portability.

There are many security measures taken by USB interface storage media. In addition to the software encryption method, there is another method as illustrated in the block diagram of a data security device of a conventional USB storage medium as shown in FIG. 1, and entitled “Data security device of USB storage medium reader as disclosed in R.O.C. Pat. No. 562203, and such method adopts a data security device 300 for the security of data transmission between a USB operating system 100 and a data storage medium 200. The data security device 300 comprises a USB mass storage class controller 310 and at least one data protection device 320, and the data protection device 320 is connected to the USB mass storage class controller 310, and further comprises a write-protect unit 321, an encrypt unit 322 and a decrypt unit 323. The write-protect unit 321 is provided for performing a data write-protect of the data storage medium 200 to prohibit an operating system other than the USB operating system 100 to write data into the data storage medium 200, so as to achieve the data security effect of the data storage medium 200. The encrypt unit 322 is provided for encrypting the written data transmitted from the USB mass storage-class controller 310, such that the data written into the data storage medium 200 can be kept confidential. The decrypt unit 323 is provided for decrypting the encrypted data to be transmitted to the USB operating system 100 via the USB mass storage-class controller 310.

Although the use of the write-protect unit 321 can prohibit another operating system to write data into the data storage medium 200, yet it implies that the data storage medium 200 can be used on the operating system only, and thus limiting the scope of using the data storage medium 200. The encrypt unit 322 can keep the data written into the data storage medium 200 confidential, and thus the filename and information of the protected data cannot be obtained from the data storage medium 200, and users have no way to know what stored data is confidential data. If users do not have a same security key, the spaces in the data storage medium 200 other than those occupied by the confidential data cannot be used, and thus causing a waste of storage capacity. Such application is definitely not friendly at all.

In summation of the description above, the data security device of the conventional USB storage medium obviously requires improvements.

### SUMMARY OF THE INVENTION

In view of the foregoing shortcoming of the prior art, it is a primary objective of the present invention to provide a data security device installed between a USB host and a USB device for executing a data transmission security. For the data encrypted by the data security device of the invention, the filename can be seen, but not the content. Further, the remaining space of the USB device other than those for storing the encrypted data can still be used, if users do not have the security key, and thus the encrypted data stored into the USB device still can be used in other hosts.

The present invention provides a data security device, applied for performing a signal transmission security between a USB device and a USB host, and the data security device comprises a first USB protocol analyzer, a second USB protocol analyzer, a file system analyzer, an encrypt unit and a decrypt unit. The first USB protocol analyzer receives a signal of the USB host, and after the signal of the USB host is identified, a first signal is outputted. The second USB protocol analyzer receives a signal of the USB device, and after the signal of the USB device is identified, a second signal is outputted. The file system analyzer is electrically connected to the first USB protocol analyzer and the second USB protocol analyzer for analyzing the content of the first signal and the content of the second signal. The encrypt unit is electrically connected to the file system analyzer for encrypting the first signal according to the file system analyzer and outputting the encrypted first signal to the USB device. The decrypt unit is electrically connected to the file system analyzer for decrypting the second signal according to a command of the file system analyzer and outputting the decrypted second signal to the USB host.

The present invention further provides a data security method, wherein a USB host signal is received, and the USB host signal is determined whether or not it is a data storage file signal, and a first signal is outputted. If the USB host signal is a data storage file signal, then a file system of the first signal will be determined whether or not it is a file system that can be encrypted. If the first signal is a file system that can be encrypted, then the content of the first signal will be analyzed, and a data block content of the first signal will be encrypted, and finally the encrypted first signal is outputted to a USB device.

With the data security device of the present invention and the method thereof, a transparent encrypted data transmission can be achieved (in other words, the filename but not the content can be seen), and the scope of using the USB storage device will not be limited (in other words, the remaining space of the USB storage device can still be used by other hosts), and the connection of the USB interface with other USB devices will not be affected (in other words, the transmitted signal can be distinguished as a data storage file signal or an operation control command signal).

To make it easier for our examiner to understand the expected objectives, technical measures and effects of the present invention, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a block diagram of a data security device of a USB storage medium according to a prior art;

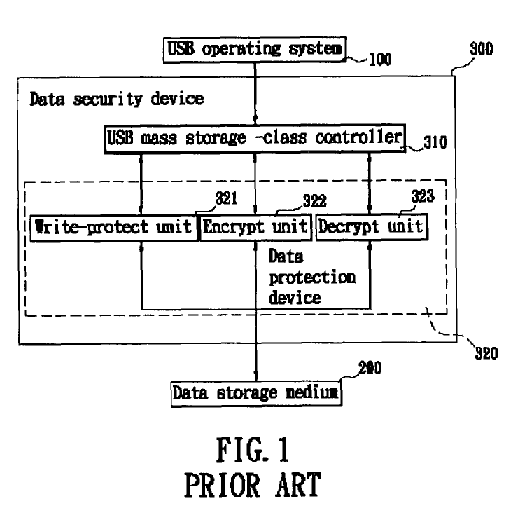

FIG. 2 is a functional block diagram of a USB system of the present invention;

FIG. 3 is a functional block diagram of a data security device of the present invention;

FIG. 4 is a schematic view of a data structure of a first signal analyzed by a file system analyzer;

FIG. 5 is a flow chart of a data security method in accordance with a first preferred embodiment of the present invention; and

FIG. 6 is a flow chart of a data security method in accordance with a second preferred embodiment of the present invention.

### DETAILED DESCRIPTION OF THE PREFERRED EMBODIMENTS

The present invention is described in details by preferred embodiments together with attached drawings as follows:

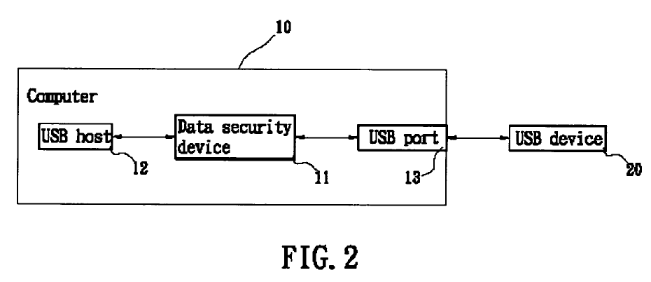

Referring to FIG. 2 for a functional block diagram of a USB system in accordance with the present invention, a data security device 11 is installed between a USB host 12 and a USB port 13 in a computer 10, and a hardware device is provided for intercepting data packets transmitted from the USB host 12 to a USB device 20. The intercepted packets are analyzed, encrypted and decrypted to protect the security of data transmitted from the USB host 12 to the USB device 20. The USB device 20 can be a USB interface device such as a mouse, a keyboard, a camera, and a storage device, and the data security device 11 is provided for identifying whether the signal transmitted from the USB host 12 to the USB device 20 is a data storage file signal or operation control command signal, such that when a data security device 11 is added between the USB host 12 and the USB port 13 to execute the security function, the use of the USB device 20 not for storage will not be affected. Further, the present invention uses hardware to protect data security, which is more difficult to crack than the encryption achieved by data encryption software.

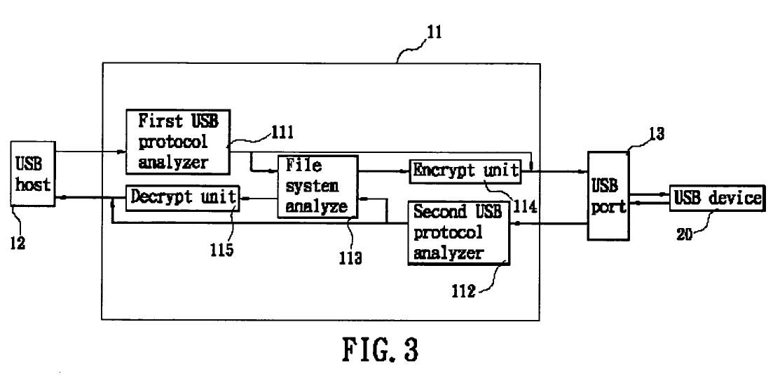

Referring to FIG. 3 for a functional block diagram of a data security device of the present invention, the data security device 11 comprises a first USB protocol analyzer 111, a second USB protocol analyzer 112, a file system analyzer 113, an encrypt unit 114 and a decrypt unit 115. The first USB protocol analyzer 111 is provided for receiving a signal of the USB host 12, identifying the received signal of the USB host 12, and outputting a first signal after the identification is completed. The second USB protocol analyzer 112 receives a signal of the USB device 20 via the USB port 13, and the received signal of the USB device 20 is identified, and a second signal is outputted after the identification is completed. The file system analyzer 113 is electrically connected to the first USB protocol analyzer 111 and the second USB protocol analyzer 112 for analyzing the content of the first signal and the content of the second signal. The encrypt unit 114 is electrically connected to the file system analyzer 113 for encrypting the first signal according to a command of the file system analyzer 113, and outputting the encrypted first signal to the USB device 20 via the USB port 13. The decrypt unit 115 is electrically connected to the file system analyzer 113 for decrypting the second signal according to a command of the file system analyzer 113 and outputting the decrypted second signal to the USB host 12.

The first USB protocol analyzer 111 identifies a signal of the USB host 12 as a data storage file signal or an operation control command signal. If the signal is a data storage file signal, the first signal outputted from the first USB protocol analyzer 111 will be transmitted to the file system analyzer 113. The file system analyzer 113 will analyze whether or not the file system is a file system of the first signal. If the file system of the first signal is in a file system format of the FAT12, FAT16 or FAT32, then the first signal will be analyzed further to find out a data block content of the first signal, and notice the encrypt unit 114 to encrypt the data block content of the first signal. After the data block content of the first signal is encrypted, the first signal is outputted to the USB device 20 to complete the data transmission security operation. If the signal of the USB host 12 identified by the first USB protocol analyzer 111 signal is a command signal of the USB device 20, then the first signal outputted by the first USB protocol analyzer 111 will not be encrypted or outputted by the file system analyzer 113 and the encrypt unit 114, but the first signal will be outputted directly to the USB device 20 via the USB port 13. If the file system of the first signal analyzed by the file system analyzer 113 is not in the file system format of the FAT12, FAT16 or FAT32, then the first signal will not be encrypted, but the first signal will be outputted directly to the USB device 20 via the USB port 13.

On the other hand, the second USB protocol analyzer 112 receives a signal of the USB device 20, and if the signal identified by the second USB protocol analyzer 112 is a response signal to the command signal of the USB device 20, then the second signal will be outputted directly to the USB host 12 without requiring an analysis by the file system analyzer 113 and the decryption by the decrypt unit 115. If the signal of the USB device 20 identified by the second USB protocol analyzer 112 is a data storage file signal, then the second signal will be transmitted to the file system analyzer 113. If the second signal analyzed by the file system analyzer 113 is an encrypted signal, then the encrypted second signal will be encrypted by the decrypt unit 115 and then outputted to the USB host 12.

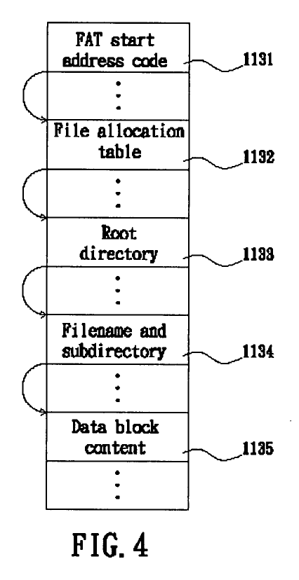

Referring to FIG. 4 for a schematic view of a data structure of a first signal analyzed by a file system analyzer, the way for the file system analyzer 113 analyzing the first signal to find out the data block content 1135 of the first signal is illustrated, and the encrypt unit 114 is instructed to encrypt the data block content 1135. After the file system analyzer 113 analyzes the file system of the first signal as a file system format of the FAT12, FAT16 or FAT32, the start address code 1131 of the file allocation table (FAT) is read. From the FAT start address code 1131, we can obtain the address of the file allocation table 1132, and the content of the file allocation table 1132 can be used for finding the address of a root directory 1133 of a first signal. From the root directory 1133, we can find out the filename and subdirectory 1134 of the data of the first signal. The subdirectory can be used for obtaining the data block content 1135 of the first signal, and the encrypt unit 114 encrypts the data block content 1135 of the first signal. Further, the filename, subdirectory 1134, root directory 1133, file allocation table 1132 and start address code 1131 of the FAT are not encrypted.

Therefore, the transparency for the encrypted data transmission can be achieved. In other words, the filename of the encrypted data can still be seen. Further, the remaining space other than the space for storing encrypted data in the USB device 20 can be used normally in the environment without the same security key, and the encrypted data stored in the USB device 20 can still be used in other hosts.

The encrypt unit 114 adopts a method of data encryption standard (DES) for encrypting a signal transmitted from the file system analyzer 113, wherein data is divided into 64-bit blocks, and a “0” bit is filled into a block less than 64 bits, until the size of the block is equal to 64 bits. The keys used by the DES for encryption and decryption are the same key which is called the master key, and its size also equals to 64 bits, wherein 8 bits are used for debugging, and the actual master key length is 56 bits. The encrypt unit 114 also adopts the advanced encryption standard (AES) for encrypting the signals transmitted from the file system analyzer 113, and its encryption algorithm adopts an iteration for encrypting data, and provides a variable block length and a variable key length, and such method is an encryption method of high confidentiality.

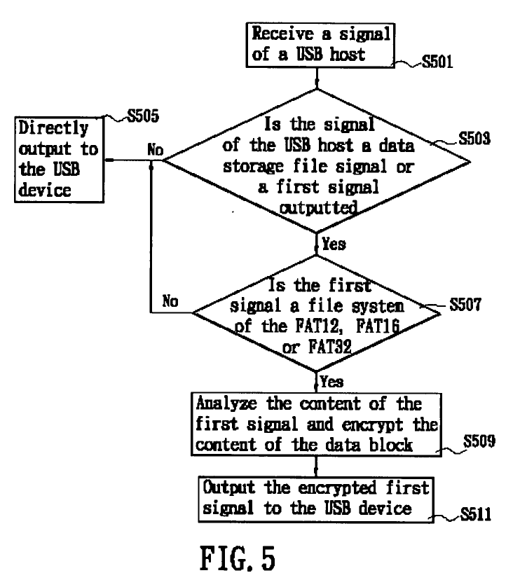

Referring to FIG. 5 for a flow chart of a data security method in accordance with a first preferred embodiment of the present invention, a first USB protocol analyzer 111 receives a signal of a USB host 12 (as shown in S501 of FIG. 5). The first USB protocol analyzer 111 determines whether or not the USB host signal is a data storage file signal, and outputs a first signal (as shown in S503 of FIG. 5). If the USB host signal is not a data storage file signal (such as a USB device command signal for controlling the USB device 20), then the first USB protocol analyzer 111 will output the first signal directly to the USB device 20 (as shown in S505 of FIG. 5). If the first signal is a data storage file signal, the first USB protocol analyzer 111 will transmit the first signal to the file system analyzer 113, and the file system analyzer 113 will analyze whether or not the file system format of the first signal is a file system that can be encrypted (as shown in S507 of FIG. 5). If the first signal is a file system that cannot be encrypted, the first signal will be transmitted and outputted directly from the encrypt unit 114 to the USB device 20 (as shown in S505 of FIG. 5). If the first signal is a file system that can be encrypted (wherein the file system having FAT12, FAT16 or FAT32 is defined as a file system that can be encrypted), then the file system analyzer 113 will analyze the content of the first signal and find out the data block content of the first signal. When the file system analyzer 113 transmits the first signal to the encrypt unit 114, the encrypt unit 114 is instructed to encrypt the data block content of the first signal (and the method for the file system analyzer 113 to analyze the first signal to find out the data block content of the first signal is shown in FIG. 4). Further, the encrypt unit 114 adopts a data encryption standard (DES) or an advanced encryption standard (AES) for the encryption (as shown in S509 of FIG. 5). Finally, the encrypted first signal is outputted to the USB device 20 (as shown in S511 of FIG. 5).

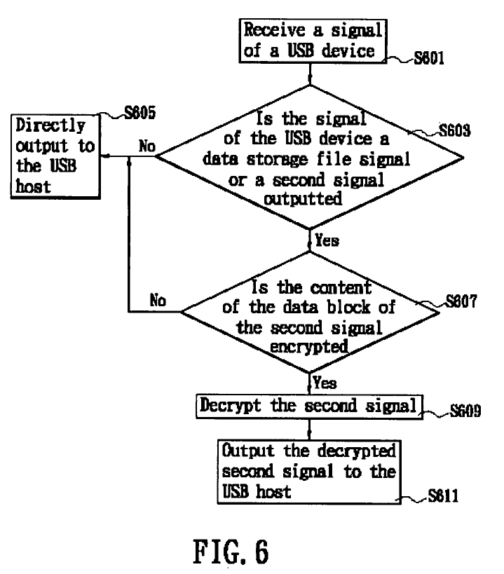

Referring to FIG. 6 for a flow chart of a data security method in accordance with a second preferred embodiment of the present invention, the second USB protocol analyzer 112 receives a USB device signal transmitted from the USB device 20 (as shown in S601 of FIG. 6). The second USB protocol analyzer 112 determines whether or not the USB device signal is a data storage file signal, and a second signal is outputted (as shown in S603 of FIG. 6). If the USB device signal is not a data storage file signal (such as a response signal of the USB device 20 to the command signal), then the second signal outputted by the second USB protocol analyzer 112 will be outputted directly to the USB host 12 (as shown in S605 of FIG. 6). If the USB device signal is a data storage file signal, then the second USB protocol analyzer 112 will transmit the second signal to the file system analyzer 113, and the file system analyzer 113 will analyze whether or not the data block content of the second signal is encrypted (as shown in S607 of FIG. 6). If the data block content of the second signal is a signal that has not been encrypted, then the second signal is outputted from the decrypt unit 115 to the USB host 12 (as shown in S605 of FIG. 6). If the data block content of the second signal is a signal that has been encrypted, then the file system analyzer 113 will transmit the second signal to the decrypt unit 115, and notice the decrypt unit 115 to decrypt the second signal (as shown in S609 of FIG. 6). Finally, the decrypted second signal is outputted to the USB host 12 (as shown in S611 of FIG. 6).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A data security device, for encrypting and decrypting data between a USB device and a USB host, comprising:
a first USB protocol analyzer, for receiving and identifying a signal of the USB host, and outputting a first signal;
a second USB protocol analyzer, for receiving and identifying a signal of the USB device, and outputting a second signal;
a file system analyzer, electrically coupled to the first USB protocol analyzer and the second USB protocol analyzer, for analyzing the content of the first signal and the content of the second signal respectively;
an encrypt unit, electrically coupled to the file system analyzer, for encrypting the first signal according to a command of the file system analyzer and outputting the first signal to the USB device; and
a decrypt unit, electrically coupled to the file system analyzer, for decrypting the second signal according to a command of the file system analyzer and outputting the second signal to the USB host.

2. The data security device as recited in claim 1, wherein the USB host signal is a data storage file signal, and after the USB host signal is identified by the first USB protocol analyzer, the first signal is transmitted to the file system analyzer for an analysis, encrypted by the encrypt unit, and transmitted to the USB device.

3. The data security device as recited in claim 1, wherein the file system of the first signal is analyzed by the file system analyzer into FAT12, FAT16 or FAT32, and the first signal is transmitted to the encrypt unit for an encryption, and then transmitted to the USB device.

4. The data security device as recited in claim 3, wherein the first signal includes a data block content, that is encrypted by the encrypt unit, and outputted to the USB device.

5. The data security device as recited in claim 1, wherein the signal of the USB host is a command signal of the USB device, and the first signal is outputted directly to the USB device after being identified by the first USB protocol analyzer.

6. The data security device as recited in claim 1, wherein the signal of the USB device is a response signal of the command signal of the USB device, and the second signal is outputted directly to the USB host after being identified by the second USB protocol analyzer.

7. The data security device as recited in claim 1, wherein the signal of the USB device is a data storage file signal, and after the signal of the USB device is identified by the second USB protocol analyzer, the second USB protocol analyzer outputs the second signal to the file system analyzer.

8. The data security device as recited in claim 7, wherein the second signal is an encrypted signal, and after the second signal is analyzed by the file system analyzer, the second signal is decrypted by the decrypt unit and outputted to the USB host.

9. The data security device as recited in claim 1, wherein the encrypt unit uses a data encryption standard (DES) to encrypt the first signal.

10. The data security device as recited in claim 1, wherein the encrypt unit uses an advanced encryption standard (AES) to encrypt the first signal.

11. A data security method, comprising the steps of:
receiving a USB host signal;
identifying whether or not the USB host signal is a data storage file signal, and outputting a first signal;
analyzing whether or not the file system of the first signal is a file system that can be encrypted, if the USB host signal is a data storage file signal;
analyzing the content of the first signal, and encrypting the data block content of the first signal, if the first signal is a file system that can be encrypted; and
outputting the encrypted first signal to a USB device.

12. The data security method as recited in claim 11, wherein the file system that can be encrypted is a file system of the FAT12, FAT16 or FAT32.

13. The data security method as recited in claim 12, further comprising a step of outputting the first signal directly to the USB device, if the first signal is a file system that cannot be encrypted.

14. The data security method as recited in claim 11, wherein the content of the first signal further comprises:
reading a start address of an information allocation table (FAT);
reading the information allocation table;
allocating the information allocation table to a root directory;
obtaining a filename and a subdirectory of the first signal from the root directory; and
obtaining a data block content of the first signal according to the root directory, and encrypting the data block content of the first signal.

15. The data security method as recited in claim 11, wherein the data block content of the first signal is encrypted by an encrypt unit that uses a data encryption standard (DES) or an advanced encryption standard (AES).

16. The data security method as recited in claim 11, further comprising a step of outputting the first signal directly to the USB device, if the USB host signal is not a data storage file signal.

17. The data security method as recited in claim 16, wherein the USB host signal is a command signal of the USB device.

18. The data security method as recited in claim 11, wherein the USB host signal is received and identified whether or not it is a data storage file signal by a first USB protocol analyzer.

19. The data security method as recited in claim 11, wherein the file system of the first signal is analyzed by a file system analyzer.

20. The data security method as recited in claim 11, further comprising the steps of:
receiving a USB device signal;
identifying the USB device signal whether or not it is a data storage file signal, and outputting a second signal;
determining whether or not a data block content of the second signal is encrypted, if the USB device signal is a data storage file signal;
decrypting the second signal, if a data block content of the second signal; and
outputting the decrypted second signal to a USB host.

21. The data security method as recited in claim 20, further comprising a step of directly outputting the second signal to the USB host, if the signal of the USB device is not a data storage file signal.

22. The data security method as recited in claim 20, further comprising a step of outputting the data content of the second signal to the USB host, if the data block content of the second signal is not encrypted.

23. The data security method as recited in claim 20, wherein the USB device signal is received and identified whether or not the data storage file signal is executed by a second USB protocol analyzer.

24. The data security method as recited in claim 20, wherein the data block content of the second signal is determined whether or not the encryption is executed by a file system analyzer.
